(19) United States
(12) Patent Application Publication
(10) Pub. No.: US 2021/0187905 A1
(43) Pub. Date: Jun. 24, 2021

(54) ONE-PLY COLD SEAL PACKAGING MATERIALS

(71) Applicant: Printpack Illinois, Inc., Elgin, IL (US)

(72) Inventors: Wil Ryan Goetsch, Maple Grove, MN (US); Fletcher Bowman, Rhinelander, WI (US)

(21) Appl. No.: 17/120,363

(22) Filed: Dec. 14, 2020

Related U.S. Application Data
(60) Provisional application No. 62/952,530, filed on Dec. 23, 2019.

(51) Int. Cl. B32B 7/12; B32B 27/08; B32B 27/34; B32B 27/32; B32B 15/20; B32B 15/088; B32B 15/085; B32B 7/03; B32B 7/06

(52) U.S. Cl. CPC B32B 7/12; B32B 2307/514; B32B 27/34; B32B 27/32; B32B 15/20; B32B 15/088; B32B 15/085; B32B 7/03; B32B 7/06; B32B 2377/00; B32B 2307/4023; B32B 2553/00; B32B 2307/7246; B32B 2307/7244; B32B 2323/10; B32B 2323/043; B32B 2311/24; B32B 27/08

(57) ABSTRACT

A packaging material can include an oriented polymer film layer, a barrier layer, a primer layer, an ink layer, a cold seal adhesive layer, and a cold seal release layer. The polymer film layer has opposite first and second sides. The barrier layer can be on the first side of the polymer film layer. The primer layer can be on the barrier layer such that the barrier layer is positioned between the primer layer and the polymer film layer. The ink layer can be on the primer layer. The cold seal release layer can be on the ink layer such that the ink layer is positioned between the cold seal release layer and the primer layer. The cold seal adhesive layer can be on the second side of the polymer film layer. The packaging material can be used as a one-ply cold seal packaging material.

### CROSS-REFERENCE TO PRIORITY APPLICATION

This application claims the benefit of U.S. Provisional Patent Application No. 62/952,530 filed Dec. 23, 2019, which is hereby incorporated by reference in its entirety.

### BACKGROUND

The present invention generally relates to packaging materials and, in particular, to flexible packaging materials that include cold seal adhesive.

It is known for two-ply cold seal packaging material to include outer and inner polymeric films that are laminated together. It is typical for the outer film to be transparent and reverse-printed so that the print is visible through the outer film in a package formed from the packaging material. Typically the inner film has barrier properties, and cold seal adhesive on the inner film forms closure seams of packages formed from the packaging material.

There is a desire for a cold seal packaging material having a different balance of properties.

### SUMMARY

An aspect of this disclosure is the provision of a flexible packaging material comprising a plurality of layers in a facing relationship with one another, wherein the layers include an oriented polymer film layer, a barrier layer, a primer layer, an ink layer, and a cold seal adhesive layer. The polymer film layer has opposite first and second sides. The barrier layer may be in a facing, contacting relationship with the first side of the polymer film layer. The barrier layer may comprise metallic material. The primer layer may be disposed on the barrier layer, such that the barrier layer is positioned between the primer layer and the polymer film layer. The ink layer may be disposed on at least a portion of the primer layer. The cold seal adhesive layer may be disposed on at least a portion of the second side of the polymer film layer.

A cold seal release layer may be disposed on the ink layer, such that the ink layer is positioned between the cold seal release layer and the primer layer. The packaging material may be formed into a roll in which the cold seal adhesive layer is releasably adhered to the cold seal release layer, and the ink layer is fixedly adhered to the primer layer.

The packaging material may be used as a one-ply cold seal packaging material. For example, the packaging material may be formed into a package in which the cold seal adhesive at least partially defines a seal of the package.

As another example, a flexible packaging material may comprise, consist essentially of, or consist of an oriented polymer film, cold seal adhesive, barrier material (e.g., metallic barrier material), primer material, ink, and cold seal release material. The polymer film has opposite first and second sides. The cold seal adhesive may be connected to at least a portion of the second side of the polymer film so that the cold seal adhesive is in a facing, contacting relationship with the second side of the polymer film. The barrier material may be connected to the first side of the polymer film so that the barrier material is in a facing, contacting relationship with the first side of the polymer film. The primer material may be connected to the barrier material so that the primer material is in a facing, contacting relationship with the barrier material, and the barrier material is positioned between the primer material and the polymer film. The ink may be connected to at least a portion of the primer material so that the ink is in a facing, contacting relationship with the primer material, and the primer material is positioned between the barrier material and the ink. The cold seal release material may be connected to the ink so that the cold seal release material is in a facing, contacting relationship with the ink, and the ink is positioned between the primer material and the cold seal release material. The packaging material may be used as a one-ply cold seal packaging material.

Another aspect of this disclosure is the provision of a method of forming a flexible packaging material. The packaging material can include barrier material fixedly disposed on an oriented polymer film. The polymer film has opposite first and second sides. The barrier material may be connected to the first side of the polymer film so that the barrier material is in a facing, contacting relationship with the first side of the polymer film. Cold seal adhesive may be applied to at least a portion of the second side of the polymer film so that the cold seal adhesive is in a facing, contacting relationship with the second side of the polymer film. Primer material may be applied to the barrier material so that the primer material is in a facing, contacting relationship with the barrier material, and the barrier material is positioned between the primer material and the polymer film. Ink may be printed on at least a portion of the primer material so that the ink is in a facing, contacting relationship with the primer material, and the primer material is positioned between the barrier material and the ink.

Cold seal release material may be applied to at least the ink so that the cold seal release material is in a facing, contacting relationship with the ink, and the ink is positioned between the primer material and the cold seal release material. The packaging material may be formed into a roll so that the cold seal adhesive is in a facing, contacting relationship with, and releasably adhered to, the cold seal release material. The packaging material may be unrolled without (e.g., substantially without) the ink and cold seal release material contaminating the cold seal adhesive, so that the packaging material may be formed into a package in which the cold seal adhesive at least partially defines a reasonably strong seal of the package.

The foregoing summary provides a few brief examples and is not exhaustive, and the present invention is not limited to the foregoing examples. The foregoing examples, as well as other examples, are further explained in the following detailed description with reference to accompanying drawings.

### BRIEF DESCRIPTION OF THE DRAWINGS

The drawings are provided as examples, and they are schematic and may not be drawn to scale. The present invention may be embodied in many different forms and should not be construed as limited to the examples depicted in the drawings.

FIG. 1 is a schematic cross-sectional view of packaging material in a flat configuration, wherein the cross-section is taken perpendicular to the length of the packaging material, in accordance with an embodiment of this disclosure.

FIG. 2 is a schematic plan view of an interior side of a wrapper portion of the packaging material of the FIG. 1, wherein the wrapper is in an open, flat configuration.

FIG. 3 is a schematic cross-sectional view of a package formed from the wrapper of FIG. 2, in accordance with an embodiment of this disclosure.

FIG. 4 is another schematic cross-sectional view of the package of FIG. 3.

### DETAILED DESCRIPTION

Various features, aspects, and advantages of the present invention will be evident from the following description and accompanying drawings. Examples of embodiments are disclosed in the following. The present invention may, however, be embodied in many different forms and should not be construed as limited to the embodiments set forth herein. For example, features disclosed as part of one embodiment or example can be used in the context of another embodiment or example to yield a further embodiment or example. As another example of the breadth of this disclosure, it is within the scope of this disclosure for one or more of the terms “substantially,” “about,” “approximately,” and/or the like, to qualify each of the adjectives and adverbs of the Detailed Description section of disclosure, as discussed in greater detail below.

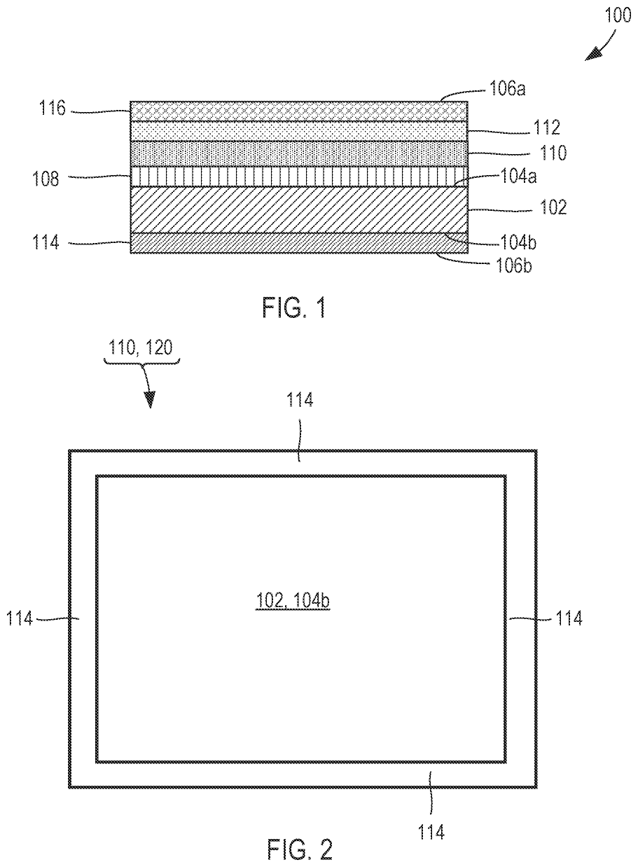

FIG. 1 schematically depicts an exemplary packaging material/composite film structure 100. The packaging material 100 may be useful as a flexible cold seal packaging material, for example, for packaging or wrapping food items.

As shown in FIG. 1, the flexible material 100 may generally include a plurality of layers in a superposed, facing, contacting relationship with one another. The layers may be continuous or discontinuous, as will be understood in the art, and as will be described further below.

More particularly, in the illustrated example, the material 100 includes a layer of oriented polymer film 102 having a first side or surface 104a and a second side or surface 104b opposite one another. The first surface 104a faces (i.e., is more proximate to) an outer side or surface 106a of the packaging material 100 and the second surface 104b faces (i.e., is more proximate to) an inner side or surface 106b of the packaging material 100.

The flexible polymer film layer 102 may generally comprise an oriented polyolefin film, for example, oriented polypropylene (OPP) or oriented polyethylene (e.g., oriented high density polyethylene). The film 102 may be oriented in one direction (e.g., machine direction) or in both directions (e.g., biaxially-oriented). Orienting the film enhances the optical clarity, stiffness, and heat resistance of the film to render it suitable for use in packaging applications. The oriented film 102 may have a thickness of from about 70 to about 130 gauge, for example, from about 80 to about 120 gauge, for example, about 115 gauge.

The packaging material 100 further includes a barrier layer 108 positioned along the first side or surface 104a of the polymer film layer 102. In some embodiments, the barrier layer 108 may generally comprise a thin layer of material deposited on the first side of the polymer film layer 102. The barrier layer 108 may comprise, for example, aluminum or aluminum oxide. More generally, the barrier layer 108 may comprise metallic material, aluminum, aluminum oxide, and/or any other suitable barrier material. The barrier layer 108 may have a thickness of from about 1 to about 100 nm, for example, from about 10 to 40 nm.

Still viewing FIG. 1, the packaging material further includes a primer layer 110 disposed on the barrier layer 108 (i.e., such that the barrier layer 108 is positioned directly between the first side 104a of the polymer film 102 and the primer layer 110). Ink 112 may be printed on the primer layer 110 (i.e., such that the primer layer 110 is positioned directly between the barrier layer 108 and the ink 112). The primer layer 110 assists with promoting adhesion of the ink 112 to the polymer film 102 by way of the barrier layer 108, as will be discussed below. In some embodiments, the primer may comprise a polyamide. However, other primers may be suitable. One example of a primer that may be suitable for the primer layer 110 is SunFuse™ Omniprime, commercially available from Sun Chemical (Northlake, Ill.). The primer 110 may typically be applied as a flood coat having a coat weight of from about 3 to about 4 lb/ream.

The packaging material 100 further includes a cold seal adhesive layer 114 disposed on at least a portion of the second side 104b of the polymer film 102. The cold seal adhesive layer 114 may typically be applied in discrete areas or regions of the film 102, and may have a coat weight of from about 2 to about 4.5 lb/ream, for example, about 3.5 lb/ream. The cold seal adhesive layer 114 at least partially defines the inner side or surface 106b of the packaging material 100.

The packaging material 100 may further include a cold seal release coating 116 (i.e., an anti-blocking coating) deposited on the ink layer 112. The cold seal release layer 116 may be transparent, translucent, or any combination thereof. The cold seal release coating 116 may comprise polyamide and a wax, and/or may comprise any other suitable components. The cold seal release coating may typically be applied as a flood coat having a coat weight of from about 0.1 to about 2 lb/ream.

As will be discussed in greater detail below, the packaging material 100 may be wound into a roll in which the cold seal adhesive 114 is in opposing, face-to-face, direct contact with, and adhered to (e.g., releasably adhered to), the release coating 116. It is believed that if the packaging material 100 did not include the primer 110 and/or the release coating 116, when the packaging material is unrolled, ink 112 may lift or separate away from the barrier layer 108 on the first side 104a of the film 102, so that ink 112 and any associated release coating 116 becomes adhered to the cold seal adhesive 114. As a result, the cold seal adhesive 114 may be contaminated (e.g., by ink 112 and any associated release coating 116), thereby adversely affecting the ability to form a sealed package from the packaging material 100. While not wishing to be bound by theory, it is believed that certain components of the cold seal adhesive 114 (possibly amine-based components) may tend to reduce the adhesion between the cold seal adhesive 114 and the release coating 116 when the packaging material 100 is formed into a roll. As discussed further below, including the primer layer 110 in the packaging material significantly improves adhesion of the ink 112 to the barrier layer 108 (e.g., metallized layer), so that the ink 112 remains deposited on the barrier layer 108 when the roll of material 100 is unwound. As a result, one-ply cold seal packaging materials can be successfully prepared and used.

Although countless possibilities are contemplated, in some embodiments, the packaging material 100 may generally have a yield of from about 20,000 to about 30,000 in²/lb, for example, about 26,000 in²/lb (as measured using ASTM D4321), a basis weight of from about 12 to about 20 lb/ream, for example, about 16 lb/ream (as measured using ASTM D646), a thickness of from about 1.3 to about 2.5 mil, for example, about 1.8 mil (as measured using ASTM F2251), a water vapor transmission rate of from about 0.005 to about 0.5 g/100 in²/24 hrs @100° F./90% RH, for example, about 0.02 g/100 in²/24 hrs @100° F./90% RH (as measured using ASTM F1249), an oxygen transmission rate of from about 1 to about 5 cc/100 in²/24 hrs @73° F./0% RH, for example, about 2.4 g/100 in²/24 hrs @73° F./0% RH (as measured using ASTM D3985), and a coefficient of friction of from about 0.1 to about 0.4, for example, about 0.25 (inside/static, inside/kinetic) and 0.35 (outside/static, outside/kinetic) (as measured using ASTM 1894). Such a material may generally be suitable for use as a wrapper (e.g., in a flow wrap process), for example, for a food item.

An example of a method of forming the packaging material 100 is described in the following, in accordance with an embodiment of this disclosure. A barrier film (e.g., a metallized film in the form of the film 102 with the barrier layer 108 fixedly thereon) may be drawn from a supply roll along a web travel path. The other layers 106, 110, 112, 116 may be applied by respective applicators positioned along the web travel path to form the packaging material 100. The packaging material 100 may be formed into a roll at a take-up spindle positioned at the downstream end of the web travel path.

The primer layer 110 may be applied directly onto the barrier layer 108 by way of an applicator positioned along the web travel path. The applicator for the primer 110 may be a flexographic printer, gravure coating device, offset gravure coating device, reverse roll coater, and/or any other suitable device for applying the at least one layer of primer material.

A print station positioned along the web travel path may include a series of printing devices (e.g., flexographic printing presses) that are spaced apart along the length of the web travel path. In one example, the primer layer 110 may be applied directly onto the barrier layer 108 by way of one or more upstream printing devices of the print station. Downstream from where the primer layer 100 is applied, ink 112 may be applied directly onto the primer layer 110 by way of one or more printing devices of the print station. As compared to one another, one or more of, several of, or each of the printing devices of the print station may be configured to print/apply a different color ink onto the primer layer 110.

The cold seal release layer 116 may be applied directly onto the ink layer(s) 112 by an applicator positioned downstream from the print station along the web travel path. The applicator for the cold seal release layer 116 may be in the form of a gravure coating device, offset gravure coating device, reverse roll coater, and/or any other suitable device for applying the at least one layer of cold seal release material.

The cold seal adhesive 114 may be applied directly onto the second side 104b of the polymer film 102 by an applicator positioned along the web travel path. The cold seal adhesive 114 may be applied in a pattern, as discussed further below. The applicator for the cold seal adhesive 114 may be in the form of a gravure coating device, offset gravure coating device, reverse roll coater, and/or any other suitable device for applying the at least one layer of cold seal adhesive.

As indicated by the above example of a manufacturing method, the packaging material 100 may be formed in an “inline system” configured so that numerous features are incorporated together along the web travel path in a single system. Alternatively, one or more of the processes or operations that have been described herein as being performed within the inline system may be performed “out of line” by separate system(s). More generally, a variety of methods and systems for forming the packaging material 100 are within the scope of this disclosure.

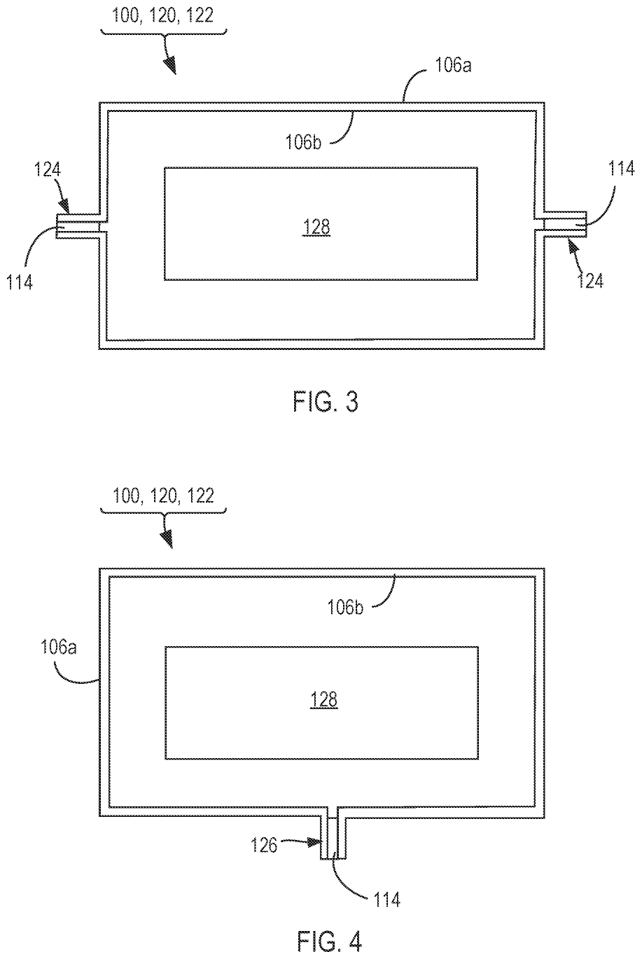

After the packaging material 100 is optionally formed into a roll as discussed above, it may be unrolled and supplied to a conventional form-fill-seal (e.g., flow wrapping) machine to form packages 122 (FIGS. 3 and 4). As an example, FIG. 2 schematically depicts an interior side of a flat, single wrapper portion 120 of the packaging material 100 that can be formed into a single package. As depicted in FIG. 2, the cold seal adhesive 114 can solely cover the margins of the interior side of the wrapper 120, so that the wrapper can be folded over onto itself to form a package 122 (FIGS. 3 and 4).

Referring to FIGS. 3 and 4, the respective strips of the cold seal adhesive 114 can be in opposing face-to-face contact with one another, and cohered to one another, to at least partially form end seals 124 and a fin seal 126 of the package 122. The fin seal 126 typically extends from one to the other of the end seals 124. Each package 122 can contain one or more articles 128, for example food products or any other suitable articles. Each package 122 can completely enclose its contents/articles 128 in a hermitically sealed manner. A wide variety of differently configured packaging materials, wrappers, packages, seals and articles are within the scope of this disclosure.

### Examples

Cold seal performance was evaluated for various packaging materials, as set forth in Table 1. Comparative samples are noted with “C-” and experimental samples of the packaging material 100 are noted with “X-”. The experimental samples of the packaging material 100 can be referred to embodiments of this disclosure, wherein the embodiments of this disclosure can be alike, except for variations noted and variations that will be apparent to those of ordinary skill in the art.

TABLE 1

| Sample | Description |
|---|---|
| C-1 | Cold seal release layer/ink/115 gauge metallized OPP/cold seal adhesive (CSA) |
| | (3.62 lb/ream CSA along the end seal and 3.27 lb/ream CSA along the fin seal) |
| X-1 | Cold seal release layer/ink/SunFuseTM Omniprime primer (~0.4 lb/ream)/115 |
| | gauge metallized OPP/cold seal adhesive (CSA) |
| | (3.62 lb/ream CSA along the end seal and 3.27 lb/ream CSA along the fin seal) |
| C-2 | Cold seal release layer/ink/115 gauge metallized OPP/cold seal adhesive (CSA) |
| | (3.21 lb/ream CSA along the end seal and 3.26 lb/ream CSA along the fin seal) |
| X-2 | Cold seal release layer/ink/SunFuse ™ Omniprime primer (~0.4 lb/ream)/115 |
| | gauge metallized OPP/cold seal adhesive (CSA) |
| | (3.21 lb/ream CSA along the end seal and 3.26 lb/ream CSA along the fin seal) |

The rolls of the sample packaging materials were subject to five different environments: Ambient (Temp/Rh), Refrigerated (40° F.), Freezer (0° F.), Oven (122° F./Ambient Rh), and Jungle (95° F./90% Rh). The samples were evaluated for cold seal adhesive strength using ASTM D1876 (80 psi, 1″ wide, serrated jaws and 0.5 second dwell) after two weeks, one month, two months, and three months.

Tables 2 and 3 present the results, where *CP denotes forced clean peel with leggy adhesive failure, SAF denotes splitting adhesive failure, and CL denotes a clean peel. Three repetitions were conducted for each test. Comparative samples C-1 and C-2 failed immediately and could not be formed into a package for evaluation. The experimental samples X-1 and X-2 of the packaging material 100 including the primer layer 110 were successfully formed into packages, as indicated below.

TABLE 2
Cold Seal Peel Values, Sample X-1

| | | | | |
|---|---|---|---|---|
| | End | End Seal * | Fin | Fin Seal * |
| Time | Seal (g) | CP (g) | Seal (g) | CP (g) |

Ambient Seal Strength

| | | | | |
|---|---|---|---|---|
| Initial | 364 | 253 | 380 | 194 |
| 2 Weeks | 441 | 298 | 392 | 353 |
| 1 Month | 405 | 272 | 360 | 310 |
| 2 Month | 501 | 339 | 427 | 362 |
| 3 Month | 495 | 315 | 436 | 373 |

Oven Seal Strength

| | | | | |
|---|---|---|---|---|
| Initial | 416 | 272 | 364 | 274 |
| 2 Weeks | 506 | 308 | 423 | 333 |
| 1 Month | 508-SAF | 370 | 445 | 390 |
| 2 Month | 522-SAF | 354 | 459 | 362 |
| 3 Month | 478 | 395 | 515 | 376 |

Jungle Seal Strength

| | | | | |
|---|---|---|---|---|
| Initial | 356 | 265 | 379 | 300 |
| 2 Weeks | 436 | 317 | 469 | 344 |
| 1 Month | 386 | 279 | 396 | 301 |
| 2 Month | 469 | 344 | 450 | 352 |
| 3 Month | 443 | 390 | 519 | 389 |

Refrigerator Seal Strength

| | | | | |
|---|---|---|---|---|
| Initial | 387 | 273 | 352 | 269 |
| 2 Weeks | 401 | 289 | 393 | 308 |
| 1 Month | 390 | 233 | 343 | 275 |
| 2 Month | 491 | 308 | 439 | 310 |
| 3 Month | 398 | 260 | 382 | 285 |

Freezer Seal Strength

| | | | | |
|---|---|---|---|---|
| Initial | 393 | 285 | 394 | 298 |
| 2 Weeks | 464 | 281 | 416 | 346 |
| 1 Month | 341 | 244 | 364 | 287 |
| 2 Month | 496 | 391 | 453 | 346 |
| 3 Month | 407 | 255 | 378 | 311 |

TABLE 3
Cold Seal Peel Values, Sample X-2

| | | | | |
|---|---|---|---|---|
| | End | End Seal * | Fin | Fin Seal * |
| Time | Seal (g) | CP (g) | Seal (g) | CP (g) |

Ambient Seal Strength

| | | | | |
|---|---|---|---|---|
| Initial | 362 | 258 | 287 | 241 |
| 2 Weeks | 357 | 228 | 311-C | 287 |
| 1 Month | 328 | 219 | 314 | 261 |
| 2 Month | 358 | 246 | 345 | 247 |
| 3 Month | 361 | 232 | 317 | 320 |

Oven Seal Strength

| | | | | |
|---|---|---|---|---|
| Initial | 339 | 262 | 254 | 234 |
| 2 Weeks | 374 | 255 | 417 | 290 |
| 1 Month | 384 | 252 | 400 | 286 |
| 2 Month | 404 | 279 | 384 | 286 |
| 3 Month | 461 | 303 | 380 | 304 |

Jungle Seal Strength

| | | | | |
|---|---|---|---|---|
| Initial | 349 | 221 | 285 | 227 |
| 2 Weeks | 394 | 260 | 342 | 270 |
| 1 Month | 331 | 232 | 299 | 246 |
| 2 Month | 356 | 252 | 364 | 273 |
| 3 Month | 425 | 274 | 390 | 286 |

Refrigerator Seal Strength

| | | | | |
|---|---|---|---|---|
| Initial | 351 | 246 | 300 | 257 |
| 2 Weeks | 362 | 229 | 304-C | 298 |
| 1 Month | 348 | 215 | 282 | 222 |
| 2 Month | 299 | 197 | 304 | 242 |
| 3 Month | 351 | 228 | 306 | 229 |

Freezer Seal Strength

| | | | | |
|---|---|---|---|---|
| Initial | 341 | 259 | 276 | 261 |
| 2 Weeks | 333 | 242 | 301-C | 238 |
| 1 Month | 300 | 234 | 274 | 223 |
| 2 Month | 329 | 222 | 299 | 238 |
| 3 Month | 330 | 296 | 322 | 232 |

To supplement the present disclosure, this application incorporates by reference the entire disclosure of U.S. Patent Application Publication No. 2020/0248038.

Reiterating from above, it is within the scope of this disclosure for one or more of the terms “substantially,” “about,” “approximately,” and/or the like, to qualify each of the adjectives and adverbs of the foregoing disclosure, for the purpose of providing a broad disclosure. As an example, it is believed that those of ordinary skill in the art will readily understand that, in different implementations of the features of this disclosure, reasonably different engineering tolerances, precision, and/or accuracy may be applicable and suitable for obtaining the desired result. Accordingly, it is believed that those of ordinary skill will readily understand usage herein of the terms such as “substantially,” “about,” “approximately,” “consisting essentially of,” and the like.

In the specification and drawings, examples of embodiments have been disclosed. The present invention is not limited to such exemplary embodiments. The use of the term “and/or” includes any and all combinations of one or more of the associated listed items. Unless otherwise noted, specific terms have been used in a generic and descriptive sense and not for purposes of limitation. While the present invention is described herein in detail in relation to specific aspects and embodiments, it is to be understood that this detailed description is only illustrative and exemplary of the present invention and is made merely for purposes of providing a full and enabling disclosure of the present invention and to set forth the best mode of practicing the invention known to the inventors at the time the invention was made.

The detailed description set forth herein is illustrative only and is not intended, nor is to be construed, to limit the present invention or otherwise to exclude any such other embodiments, adaptations, variations, modifications, and equivalent arrangements of the present invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, various elements discussed with reference to the various embodiments may be interchanged to create entirely new embodiments coming within the scope of the present invention.

What is claimed is:

1. A flexible packaging material comprising:
a plurality of layers in a facing relationship with one another, the plurality of layers comprising:
an oriented polymer film layer having a first side and a second side opposite one another;
a barrier layer in a facing, contacting relationship with the first side of the oriented polymer film layer;
a primer layer disposed on the barrier layer, such that the barrier layer is positioned between the primer layer and the oriented polymer film layer;
an ink layer disposed on at least a portion of the primer layer; and
a cold seal adhesive layer disposed on at least a portion of the second side of the oriented polymer film layer.

2. The flexible packaging material of claim 1, wherein the cold seal adhesive layer at least partially defines an inner surface of the packaging material.

3. The flexible packaging material of claim 2, wherein the flexible packaging material further comprises a cold seal release layer disposed on the ink layer, such that the ink layer is positioned between the cold seal release layer and the primer layer.

4. The flexible packaging material of claim 3, wherein the cold seal release layer at least partially defines an outer surface of the packaging material.

5. The flexible packaging material of claim 1, wherein the primer layer comprises a polyamide.

6. The flexible packaging material of claim 1, wherein the primer layer has a weight of from about 3 to about 4 lb/ream.

7. The flexible packaging material of claim 1, wherein the oriented polymer film comprises polypropylene or high density polyethylene.

8. The flexible packaging material of claim 1, wherein the oriented polymer film has a thickness of from about 70 to about 130 gauge.

9. The flexible packaging material of claim 1, wherein the barrier layer comprises at least one of aluminum and aluminum oxide.

10. The flexible packaging material of claim 1, wherein the flexible packaging material has a yield of from about 20,000 to about 30,000 in²/lb as measured using ASTM D4321.

11. The flexible packaging material of claim 1, wherein the flexible packaging material has a basis weight of from about 12 to about 20 lb/ream.

12. The flexible packaging material of claim 1, wherein the flexible packaging material has a thickness of from about 1.3 to about 2.5 mil.

13. The flexible packaging material of claim 1, wherein the flexible packaging material has a water vapor transmission rate of from about 0.005 to about 0.5 g/100 in²/24 hrs @100° F./90% RH as measured using ASTM F1249.

14. The flexible packaging material of claim 1, wherein the flexible packaging material has an oxygen transmission rate of from about 1 to about 5 cc/100 in²/24 hrs @73° F./0% RH as measured using ASTM D3985.

15. The flexible packaging material of claim 1, wherein the flexible packaging material has a coefficient of friction of from about 0.1 to about 0.4.

16. The flexible packaging material of claim 1, wherein:
the flexible packaging material has opposite first and second surfaces;
a cold seal adhesive layer at least partially defines the first surface of the packaging material; and
the flexible packaging material is formed into a roll in which:
the cold seal adhesive layer is releasably adhered to second surface of the packaging material, and
the ink layer is fixedly adhered to the primer layer.

17. A package formed from the flexible packaging material of claim 1, wherein:
the cold seal adhesive at least partially defines a seal of the package; and
at least one article is contained by the package.

18. A flexible packaging material consisting essentially of:
an oriented polymer film having a first side and a second side opposite one another;
cold seal adhesive connected to at least a portion of the second side of the oriented polymer film so that the cold seal adhesive is in a facing, contacting relationship with the second side of the oriented polymer film;
metallic barrier material connected to the first side of the oriented polymer film so that the metallic barrier material is in a facing, contacting relationship with the first side of the oriented polymer film;
primer material connected to the metallic barrier material so that the primer material is in a facing, contacting relationship with the metallic barrier material, and the metallic barrier material is positioned between the primer material and the oriented polymer film;
ink connected to at least a portion of the primer material so that the ink is in a facing, contacting relationship with the primer material, and the primer material is positioned between the metallic barrier material and the ink; and
cold seal release material connected to at least the ink so that the cold seal release material is in a facing, contacting relationship with the ink, and the ink is positioned between the primer material and the cold seal release material.

19. A method of forming a flexible packaging material, wherein the flexible packaging material comprises an oriented polymer film and barrier material, the oriented polymer film has a first side and a second side opposite one another, and the barrier material is connected to the first side of the oriented polymer film so that the barrier material is in a facing, contacting relationship with the first side of the oriented polymer film, and wherein the method comprises:
applying cold seal adhesive to at least a portion of the second side of the oriented polymer film so that the cold seal adhesive is in a facing, contacting relationship with the second side of the oriented polymer film;
applying primer material to the barrier material so that the primer material is in a facing, contacting relationship with the barrier material, and the barrier material is positioned between the primer material and the oriented polymer film; and
printing ink on at least a portion of the primer material so that the ink is in a facing, contacting relationship with the primer material, and the primer material is positioned between the barrier material and the ink.

20. The method of claim 19, further comprising:
applying cold seal release material to at least the ink so that the cold seal release material is in a facing, contacting relationship with the ink, and the ink is positioned between the primer material and the cold seal release material; and
forming the flexible packaging material into a roll so that the cold seal adhesive is in a facing, contacting relationship with, and releasably adhered to, the cold seal release material.
